(19) United States
(12) Patent Application Publication
(10) Pub. No.: US 2026/0100857 A1
(43) Pub. Date: Apr. 9, 2026

(54) METHODS, ARCHITECTURES, APPARATUSES AND SYSTEMS FOR ACCESS TRAFFIC STEERING, SWITCHING AND SPLITTING

(71) Applicant: InterDigital Patent Holdings, Inc., Wilmington, DE (US)

(72) Inventors: Achref Methenni, Montreal (CA); Michael Starsinic, Newtown, PA (US); Samir Ferdi, Kirkland (CA); Saad Ahmad, Montreal (CA); Ulises Olvera-Hernandez, Saint-Lazare (CA)

(21) Appl. No.: 18/905,815

(22) Filed: Oct. 3, 2024

(51) Int. Cl. H04L 12/14; H04L 43/08; H04L 65/1069

(52) U.S. Cl. CPC H04L 12/1407; H04L 43/08; H04L 65/1069

(57) ABSTRACT

Procedures, methods, architectures, apparatuses, systems, devices, and computer program products for reporting of measurements. A wireless transmit-receive unit (WTRU) may initiate a multi-access packet data unit (MA PDU) session establishment request, incorporating energy-aware access traffic steering, switching and splitting (ATSSS) capabilities and an indication of preferred energy-based user plane optimization. The session management function (SMF) receives the request and sends a session management (SM) policy association create to the policy control function (PCF). The PCF obtains an energy estimate report for traffic flows and QoS flows, for both access legs of the MA PDU session, uses the report to generate policy and charging control (PCC) rules, and sends these rules to the SMF, which derives ATSSS rules for the WTRU and N4 rules for the user plane function (UPF), that include energy aware traffic steering policies.

### INCORPORATION BY REFERENCE

The following documents are incorporated by reference in their entirety: 3GPP TR 23.700-66, “Study on Energy Efficiency and Energy Saving”, Release 19, V19.0.0 (2024-09); 3GPP TS 23.501, “System architecture for the 5G System (5GS), Stage 2”, V19.1.0 (2024-09); 3GPP TS 23.502, “Procedures for the 5G System (5GS), Stage 2”, V19.1.0 (2024-09); 3GPP TS 23.503, “Policy and charging control framework for the 5G System (5GS); Stage 2 (2024-09)”, V19.1.0.

### BACKGROUND

The present disclosure is generally directed to the fields of communications, software and encoding, including, for example, to methods, architectures, apparatuses, systems related to radio communications in wireless networks.

### SUMMARY

There are disclosed embodiments of methods, as described in the following and as claimed in the appended claims.

There are disclosed embodiments of a device, as described in the following and as claimed in the appended claims.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is configuring WTRU and UPF with energy aware steering policies and energy measurement methods using 3GPP and non-3GPP energy related information;

FIG. 3 is triggering of PCF to jointly determine, by the PCF, QoS parameters and steering policies, to optimize UP energy efficiency;

FIG. 4 is a procedure for single access to MA PDU session conversion based on access types related UP energy related information;

FIG. 5 is a sequence chart of an embodiment implemented by a wireless transmit-receive unit (WTRU);

FIG. 6 is a flow chart of a method according to an embodiment of a method implemented by a network node; and

FIG. 7 is a flow chart of a method according to an embodiment implemented by a WTRU.

### DETAILED DESCRIPTION

### Abbreviations and acronyms

5GS 5G System
AF Application Function
AMF Access and Mobility Management Function
AN Access Network
ARP Allocation and Retention Priority
AS Application Server
ATSSS Access Traffic Steering, Switching and Splitting
DL Downlink
DNN Data Network Name
EC Energy Cost
EE Energy Efficiency
EECF Energy Efficiency Control Function
GBR Guaranteed Bit Rate
ID Identifier
MA Multi-Access
MAR Multi-Access Rule
Mbps Megabits per second
MBR Maximum Bit Rate
ML Machine Learning
MOS Mean Opinion Score
N3IWF Non-3gpp Interworking Function
NAS Non-Access Stratum
NEF Network Exposure Function
NWDAF Network Data Analytics Function
PCC Policy and Charging Control
PCF Policy Control Function
PDB Packet Delay Budget
PDU Packet Data Unit
PER Packet Error Rate
PLR Packet Loss Rate
PSA UPF PDU Session Anchor UPF
QoE Quality of Experience
QoS Quality of Service
RAN Radio Access Network
RAT Radio Access Technology
RTT Round Trip Time
SDF Service Data Flow
SM Session Management
SMF Session Management Function
S-NSSAI Single Network Slice Selection Assistance Information
TNGF Trust Non-3GPP Gateway Function
UE User Equipment
UL Uplink
UP User Plane
UPF User Plane Function

### Terminology, Principles and Observations

New procedures are described herein, that may involve the EECF or NWDAF. The functionality that is described herein as taking place in the EECF may instead take place in the NWDAF. The functionality that is described herein as taking place in the NWDAF may instead take place in the EECF.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

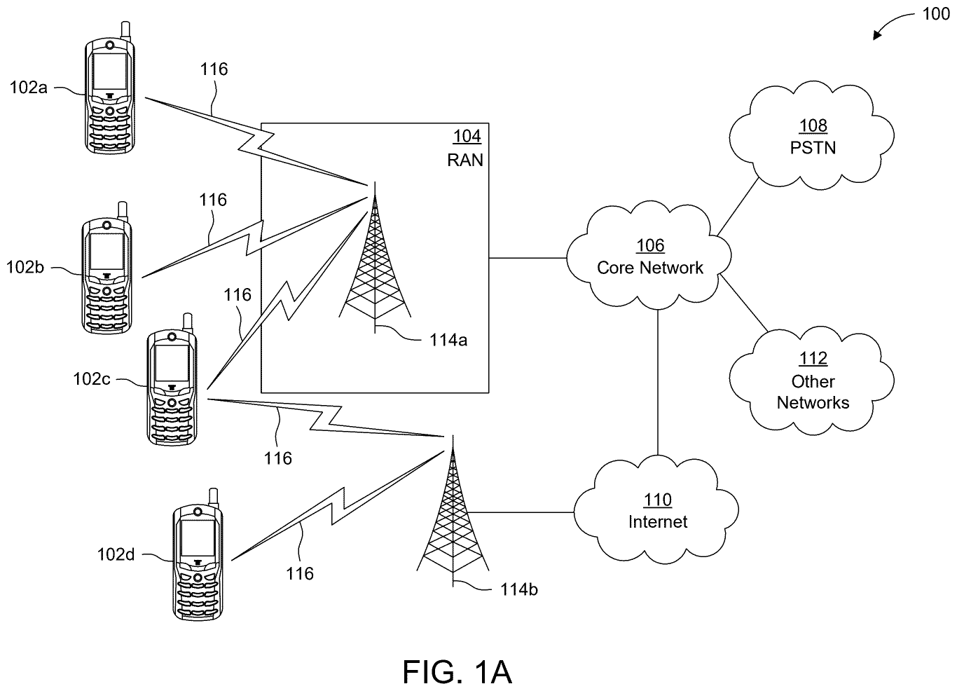

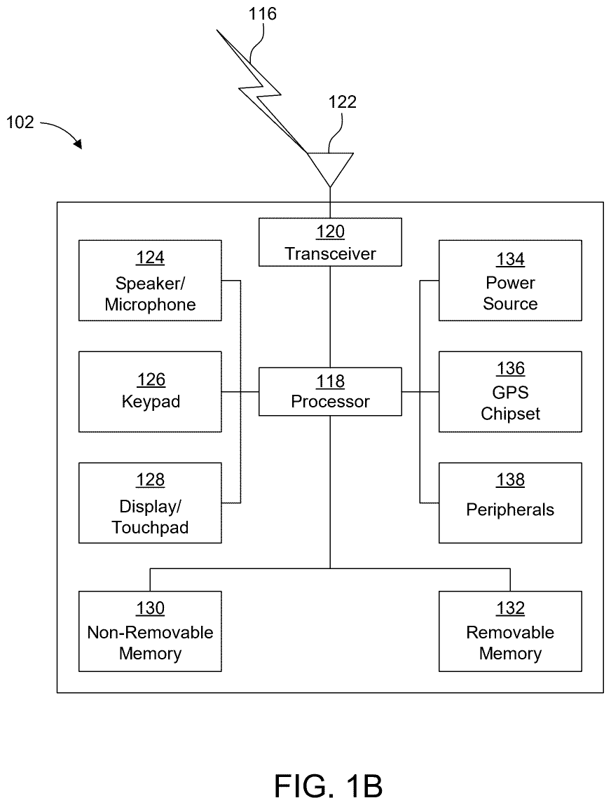

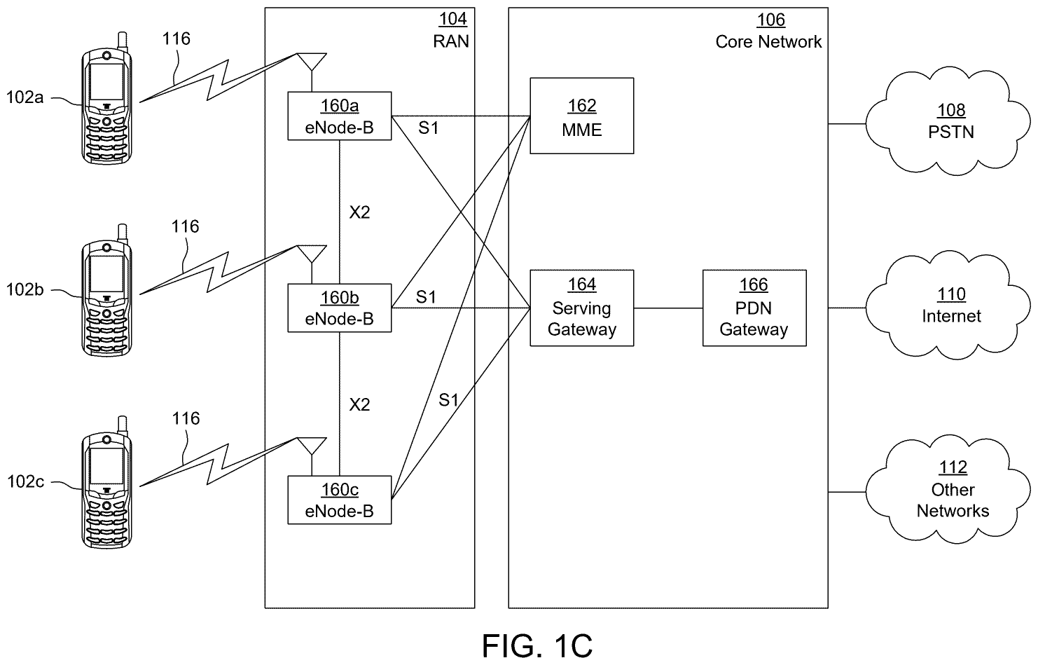

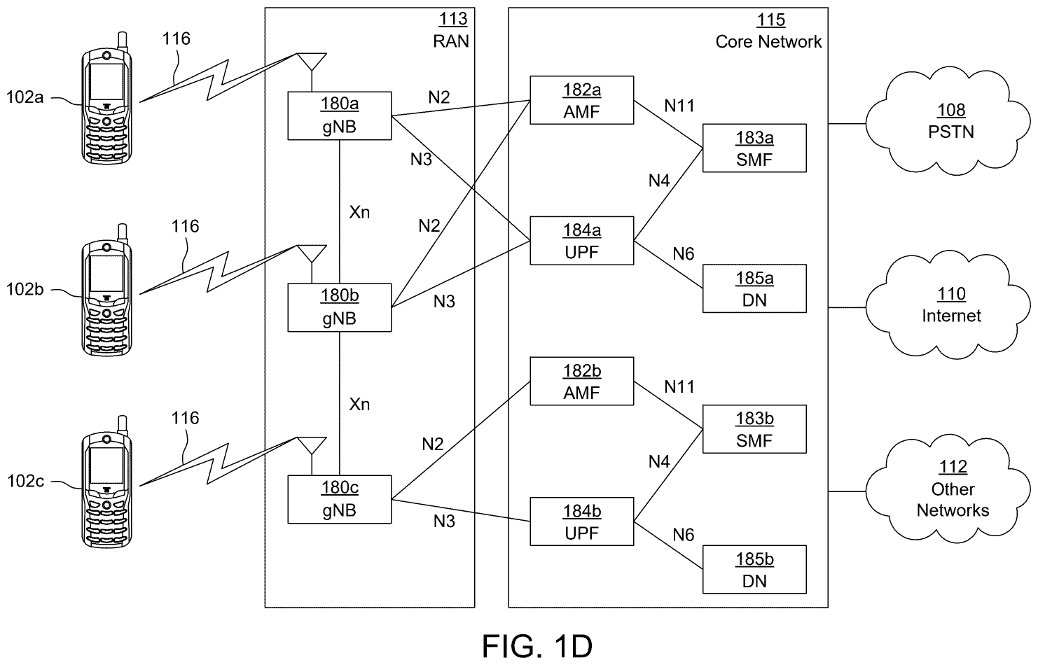

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Multi-access PDU Session establishment and ATSSS rules

A WTRU that supports ATSSS feature may initiate a Multi-access PDU session Establishment request to the 5GS. The WTRU provides a Request Type as “MA PDU session” in an Uplink NAS Transport message and provides its ATSSS capabilities in the PDU session Establishment request.

An AMF serving the WTRU that supports ATSSS may perform SMF selection for an SMF that supports ATSSS. The AMF informs the SMF that the request is a MA PDU session request. The SMF checks whether the MA PDU session is allowed.

The SMF may sends request to the PCF to create SM policies for MA PDU session and includes the ATSSS capabilities of the MA PDU session.

The PCF may provide PCC rules for the PDU session that include MA PDU session control information.

The SMF receives the PCC rules from the PCF, and derives N4 rules for the UPF, as well as ATSSS rules for the WTRU.

The N4 rules and ATSSS rules include information on how to steer a traffic that is carried within the MA PDU session, over the first access leg and second access leg. A leg refers to a path between the WTRU and a UPF. For example, a first access leg may go from the WTRU to a cellular base station to a UPF. A second access leg may go from the UE to a Wi-Fi access point, to an N3IWF or TNGF and then to the UPF.

The ATSSS framework enables the 5GS to carry user plane traffic between a WTRU and a PSA UPF, using two access networks, one 3gpp access and one non 3gpp access.

The 5GS defines different steering functionalities and steering modes that can be used to steer, switch or split traffic of an application traffic, carried within a multi-access PDU session.

For a GBR QoS flow, the steering mode active standby and redundant mode are defined.

The active standby steering mode is used to steer traffic that matches a service data flow to one access (the active access), when this access is available, and to switch the traffic of the SDF to the available other access (the Standby access), when active access becomes unavailable. When the active access becomes available again, the SDF is switched back to this access,

If standby access is not indicated, then the SDF cannot be transferred on another access.

For non GBR QoS flows, steering modes such as smallest delay, load balancing, priority based and redundant are defined.

Also, both accesses are intended to support the QoS flow parameters. The QoS rules are determined independently of the access type.

On the other hand, the ATSSS rules and MAR rules in the N4 rules define how the traffic should be delivered through the different access legs.

In terms of energy awareness, the ATSSS framework does not support using energy related metrics to define QoS rules or ATSSS rules for the application traffic of a MA PDU session.

There is a solution in the SA2 EnergySys TR 23.700-66, which proposes that energy cost or efficiency is calculated, and if it does not satisfy a threshold, then a steering decision can take place, such as moving traffic to a different access or split traffic percentage change.

However, the ATSSS rules themselves do not reflect how the EE or EC can be used to select traffic ATSSS.

The approach to use the NWDAF/EECF to obtain energy estimates may be slow and not allow a timely update of steering configuration when EE or EC threshold is exceeded.

The current approach for ATSSS, QoS parameters is determined completely separate from other access used. However, the same QoS parameters may incur a different EC or EE for the QoS flow, depending on the access used.

Hence enhancements to the 5GS system are needed, to allow a faster adjustment of traffic steering based on EE or EC information, to allow better QoS and ATSSS determination for a better EE.

### Energy Aware ATSSS Configuration (PCF Actions)

Operations that may be performed by a PCF according to an embodiment follow.

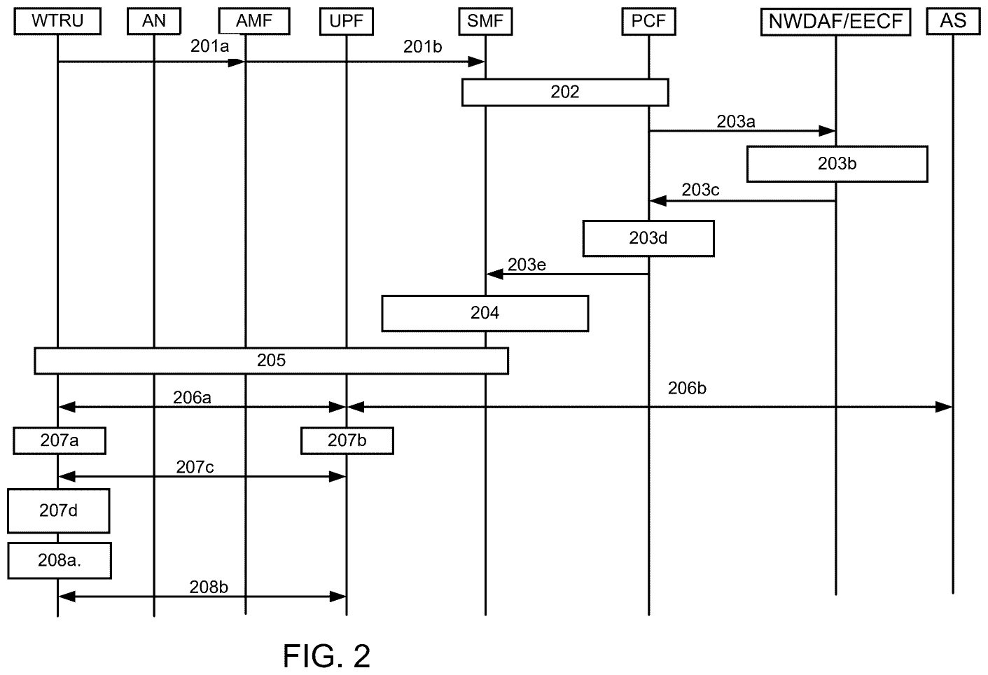

First (see step 202, FIG. 2), receives a request for PCC rules from an SMF. The request includes an indication that the policy association is for an MA PDU session and that optimization of policies for energy consumption is requested.

(see section “Converting a single access PDU session to a MA PDU session based on energy related information” further on in this document) The PCF receives a target QoE for one or more flows of the PDU session. The Target QoE is received from the SMF or from an AF.

The PCF may also receive desired QoS parameters for flows of the PDU session.

Second (step 203a, FIG. 2), the PCF sends a request to an EECF to obtain energy related information for the MA PDU session. The request includes the identity of the RAN Node, N3IWF or TNGF, and PSA UPF that serve the PDU session.

The request may also include the DNN and S-NSSAI that are associated with the PDU session.

The request may also include the target QoE for one or more flows of the PDU session.

The request may also include the desired QoS parameters for flows of the PDU session.

Third (step 203b and 203c, FIG. 2), the PCF receives an energy estimate report from the EECF. The report includes energy estimate information for at least 2 access legs of the PDU session.

The energy estimate report indicates an energy consumption that can be assumed for each access leg relative to a target data rate.

The energy estimate report indicates an energy consumption that can be assumed for each access leg relative to a target QoE metric value.

Fourth (step 203d, FIG. 2), the PCF uses the energy estimate report to derive PCC rules.

The target QoE for one or more flows of the PDU session may also be used to derive the PCC rules.

The desired QoS parameters for flows of the PDU session may also be used to derive the PCC rules.

Fifth (step 203e, FIG. 2), the PCF sends the PCC rules to the SMF.

Based on the energy estimate report, the PCF includes, in the PCC rules, an indication that an energy aware steering mode should be enabled for the PDU session.

Based on the energy estimate report, the PCF includes, in the PCC rules, energy balancing metrics that can be used to determine whether a PDU of the PDU session should be transmitted over a first access leg or a second access leg.

Based on the energy report, the PCF includes, in the PCC rules, parameters (e.g., SDF split percentages) and threshold values (e.g., minimum energy efficiency value) related to the energy balancing metrics.

Based on the energy estimate report, the PCF includes, in the PCC rules, energy related measurement methods and parameters (e.g., a measurement period) to be used by the WTRU and the UPF.

Based on the energy estimate report, the PCF includes, in the PCC rules, energy measurement function templates with corresponding parameters, that enable the WTRU and the UPF to calculate energy estimates.

The SMF may configure the WTRU and UPF with energy aware steering policies based on energy information on both 3gpp and non-3gpp accesses.

According to embodiments the 5GS takes energy related aspects into consideration when an MA PDU session is being setup between a WTRU and a PSA UPF.

See FIG. 2, wherein, according to an embodiment, the WTRU and UPF are configured with energy-aware steering policies and energy measurement methods using 3GPP and non-3GPP energy related information.

In step 201a and 201b, the WTRU may send a PDU session establishment request message to the 5GS, e.g., a PDU session establishment request (with parameters Request type=“MA PDU Request”, energy aware ATSSS capabilities, energy related UP optimization preference). The WTRU may send this request to the 5GS via the 3gpp or non 3gpp access.

The request message may include a request type “MA PDU Request” in UL NAS transport message to indicate that the request PDU session type is a multi-access PDU session.

The WTRU may also include, in the UL NAS transport message, its ATSSS capabilities. The ATSSS capabilities may describe steering modes that the WTRU supports. The ATSSS capabilities may include new energy aware steering modes, described further on in this document.

The request message may also include an indication that UP energy optimization is preferred for this PDU session.

Once the AMF receives the WTRU request, the AMF may perform SMF selection. The AMF may use the request type being “MA PDU session”, together with the indication that the UP energy optimization is preferred, and the support of energy aware steering modes, to select the SMF.

For example, the AMF may select an SMF that supports ATSSS and that supports energy aware MA PDU session management.

The SMF may in turn perform PCF selection.

In step 202 (Authorize SMF request, determine QoS parameters for the MA PDU session), the SMF sends a message to the PCF to establish a session management policy association. The SMF sends a SM Policy Control Create message to the PCF and includes in the message the indication “MA PDU Request” for the PDU session type. The SMF may also include the indication that UP energy optimization is preferred, and the ATSSS capabilities of the MA PDU session (with the energy aware steering modes).

Once the PCF accepts the SMF request, the PCF may determine QoS parameters (i.e. PCC rules) for the traffic flows of interest for the MA PDU session.

In step 203a (Request energy information for the data flow for both access nodes), the PCF may determine, based on the information included in the SMF request for SM Policy association for a MA PDU session, together with the energy aware steering capabilities and UP energy optimization preference indication, determines to obtain energy related information from the NWDAF (or EECF).

The PCF may send a request to the NWDAF to obtain energy related information for the MA PDU session.

Since this PDU session is being established, the 5GS may not have full data or parameters available to provide to the NWDAF so that the NWDAF can predict the energy cost related to the MA PDU session. For example, the WTRU may have not exchanged data traffic within the PDU session yet, which could be used as input to the NWDAF when estimating energy efficiency or energy consumption for the UP path. However, the request from the PCF to the NWDAF may provide the DNN and S-NSSAI that is associated with the PDU session and the NWDAF may use this information to infer the type of traffic that might need to be sent in the PDU session.

At this stage, the PCF may include in the request to the NWDAF, the WTRU ID, RAN ID, N3IWF ID (or TNGF ID), UPF ID, DNN and S-NSSAI values, QoS parameters. The PCF may also include an application ID if available.

The PCF may include GBR and MBR for the GBR traffic flows as well as QoS parameters such as PDB, PER and ARP.

In step 203b (Calculate estimates/predictions about UP energy efficiency/consumption for both access nodes), the NWDAF determines an estimate of the energy efficiency of both access leg (i.e., the 3gpp access and the non 3gpp access) of the MA PDU session. This estimate may be determined based on previous data and represent statistics about the EE performance of each access, e.g., when using UPF ID, RAN ID, N3IWF ID (or TNGF ID), DNN, S-NSSAI, and default/requested QoS parameters.

The NWDAF may determine an energy efficiency value associated with the QoS parameters, for each access used to deliver the data traffic to and from the WTRU.

The NWDAF may provide an estimate of the energy efficiency of a QoS flow, or service data flow, using the QoS parameters, when the data traffic is carried via the 3gpp/non-3gpp access within the MA PDU session.

The NWDAF may provide multiple values of the energy efficiency estimate, for different potential values of data volume or data rate used for the traffic flow.

For example, the NWDAF may indicate that the energy efficiency for the traffic flow using 3gpp access, is EE1=0.6 for data rate 1=5 Mbps, EE2=0.7 for data rate 2=10 Mbps (e.g., for a given data volume size), and the energy efficiency estimate of the same traffic flow carried over non 3gpp access, would have values EE3=0.55 for data rate1 and EE4=0.71 for data rate 2.

The NWDAF may provide an estimate of the average energy consumption if a service data flow is carried by a QoS flow using the 3gpp or the non-3gpp access. The NWDAF may provide the estimate of the average energy consumption, given different values of the data volume and data rate for the service data flow.

For example, the NWDAF may indicate that the average energy consumption for the traffic flow using 3gpp access, is EC1=8 for data rate 1=5 Mbps, EC2=12 for data rate 2=10 Mbps, whereas the average energy consumption of the same traffic flow carried over non-3gpp access, would be EC3=8 for data rate1 and EC4=11 for data rate 2.

The NWDAF may provide both the information related to the energy efficiency and the average energy consumption for each access.

The information that the NWDAF determines in this step is added to an energy estimate report by the NWDAF.

In step 203c (Send energy estimate report to the PCF), the NWDAF may send the energy estimate report to the PCF.

In step 203d (Generates PCC rules including MA PDU session control information (energy aware steering modes)), the PCF uses the energy estimate report provided by the NWDAF, and the service requirements (e.g., QoS parameters) related to the QoS flow, (at this stage the default QoS flow), to derive PCC rules for the traffic flow(s) of interest.

The PCC rules include MA PDU session control information. The MA PDU session control information may include application descriptor information, steering functionality, a steering mode for the traffic flow of interest.

### Energy-Aware Steering Modes

For a non-GBR traffic flow, new energy aware steering modes can be used to steer traffic within the MA PDU session.

A first energy aware steering mode may be a highest energy efficiency or largest EE steering mode.

This steering mode can be used by the WTRU and UPF to steer a traffic flow to the access that is determined to have a higher energy efficiency value than the other access.

A similar energy aware steering mode may be called, smallest average energy consumption mode. This steering mode can be used by the WTRU and UPF to steer an SDF traffic on the access that incurs a lower average energy consumption or EC. Once this access becomes unavailable, the SDF is switched to the other access.

A second energy aware steering mode is an energy aware balancing, where the SDF is split across both accesses, if both accesses are available. This steering mode include split percentage values, to account for the percentage of the service data flow is carried via the first and second access. The split percentages of this steering mode may be determined based on energy related information, e.g., energy efficiency threshold or average energy consumption threshold.

For example, if the estimated or predicted value for the energy efficiency for the 3gpp access is 0.5 and the estimated EE value for the non 3gpp access is 0.3, and if a target average energy efficiency level for the SDF is 0.4 or above, then the SDF traffic may be split over both accesses, using a split percentage of 50%-50%. This means that 50% of the SDF traffic is to be sent over 3gpp access, and the 50% of the SDF traffic is to be sent over the non 3gpp access. Using this steering mode, the average energy efficiency level for the SDF is 0.5*50%+0.3*50%=0.8/2=0.4.

Alternatively, the energy aware balancing mode may use estimates or predictions about the average energy consumption for both accesses, to determines the SDF split percentage, e.g., in order to balance SDF traffic across both accesses while not exceeding a certain average energy consumption threshold.

A third energy aware steering mode is an energy aware priority based steering mode.

This steering mode is used by the WTRU and UPF to steer all traffic of a service data flow to one access, selected as high priority access, where the selection of the high priority access for the SDF takes into consideration estimates or predictions of the energy efficiency or the average energy consumption related to the 3gpp access and the non 3gpp accesses.

When the high priority access becomes congested, then the SDF traffic is split between the high priority and the low priority access. When the high priority access becomes unavailable, then all the SDF traffic is sent over the low priority access.

For example, if the estimated EE level for the 3gpp access is 0.6 and the estimated EE level for the non 3gpp access is 0.2, then the 3gpp access may be selected as a high priority access for the SDF, while the non 3gpp access is selected as the low priority access for the SDF.

When the 3gpp access becomes congested, then the traffic of the SDF is split over both accesses, e.g., using a 40%-60% split. When the 3gpp access becomes unavailable, then all the SDF traffic is sent over the non 3gpp access.

The WTRU and UPF may be provided with threshold parameters to help determine whether the access is congested. The thresholds can be an RTT, PLR or an energy related threshold (e.g., energy efficiency level, or average energy consumption level).

The SMF includes an energy aware steering mode in the ATSSS rules to be sent to the WTRU and the N4 rules to be sent to the UPF.

For a GBR traffic flow, a new energy aware steering mode can be used to steer traffic within the MA PDU session.

The SMF may use the energy efficiency estimate provided by the NWDAF, to select the access network that has a higher energy efficiency value. For example, if the 3gpp access has an estimate or average or predicted energy efficiency value of 0.6, and the non-3gpp access has an estimate or average or predicted energy efficiency value of 0.2, then the SMF may select the 3gpp access to carry the GBR QoS flow of interest.

The SMF may alternatively consider an estimate or average or prediction of the energy consumption related to the UP path using the 3gpp access and the non-3gpp access and may select the GBR QoS flow to be carries using the UP path of the access that has less energy consumption estimate or predicted value.

The SMF may determine an energy aware active-standby steering mode for the UPF and WTRU to use when sending traffic. The energy aware active-standby steering mode indicates a first access network that is an active access network and having the better energy efficient path.

Then if the first access node become unavailable, if the second access node is available then the SMF may select the second access node as the active access, until the first access node become available again.

The energy aware active-standby steering mode may also be associated with a threshold on the energy efficiency or average energy consumption, which may indicate the threshold beyond which an access may be considered high energy efficiency or low average energy consumption.

The SMF may determine that an access is an active access if the EE estimate for a traffic flow or QoS flow carried over that access is above a certain threshold. In this case, either access may be considered as active (and the other access would be considered standby access), as long as that access has high EE or low average EC.

Also, in order to move the GBR QoS flow from one access to the other access, not only does the second access need to have a higher energy efficiency estimate than the first access, but the improvement to the energy efficiency level must be noticeable (above a certain delta) otherwise, it might be useful to keep using the first access, as long as it has EE above a certain threshold.

The SMF may determine an energy aware active steering mode. This steering mode is similar to the energy aware active-standby steering mode, where one access is considered active, according to UP energy related considerations. If the active access becomes unavailable, then the traffic that is carried over this access may not be switched to the other access, as it is not considered as a standby access.

This steering mode may also be associated with an energy related (EE or EC) threshold.

The energy aware steering modes described before, rely on measurements that are similar to access performance measurements defined for standard ATSSS framework.

It is proposed to introduce a new access performance measurement related to energy efficiency or average energy consumption for the access.

Similar to the RTT and PLR, it is proposed that the WTRU and UPF are able to determine measurements or estimates related to the EE or EC of a certain access.

The WTRU and the UPF may decide to estimate the EE or Average EC for a service data flow over both 3gpp and non 3gpp access. For example, if the WTRU and UPF are provided with steering modes for the SDF that use an EE or average EC threshold, then the WTRU and UPF may determine to perform EE (or Average EC) measurements.

According to an embodiment, in a first option, the UPF may obtain a measurement or estimate of the EE from the NWDAF.

The UPF may be able to request the NWDAF for the EE/EC measurements related to the traffic flow of interest, or request such estimates via the SMF (i.e., the SMF sends an energy estimate report request to the NWDAF and forwards the obtained report to the UPF).

To be able to obtain accurate estimates, the UPF may need to report measurements of the data volume and/or data rate related to the SDF or the QoS flow carrying the SDF using the specific access. In this case, the WTRU may send data volume and data rate measurements (e.g., for the UL traffic) to the UPF via the user plane. The UPF may consolidate the data volume and data rate measurement obtained from the WTRU, with the UPF's own measurement of the DL traffic data volume and data rate. The UPF may then send the consolidated information either directly to the NWDAF or via the SMF, to be able to obtain an accurate estimate of the energy efficiency or average energy consumption for the access.

According to an embodiment, in a second option, the WTRU and UPF may be configured with some simplified (deterministic) functions that can be used to derive an estimate of the energy efficiency or average energy consumption.

For example, the NWDAF may use a function that has multiple parameters and input variables to be able to accurately estimate the EE or Average EC related to an SDF for a certain access. The NWDAF may even use estimates or predictions derived from ML models, using the assistance of NWDAF analytics. Usually, the ML model can use multiple parameters and features to be able to be trained to provide accurate enough predictions or estimates.

The EECF or another network function (e.g., the PCF) may determine from the NWDAF an EE or Average EC estimation function, a simpler function(s) (e.g. with fewer parameters and variables and which is deterministic) that can be used by the WTRU and the UPF to provide good enough estimates of the EE/EC.

A simpler function may use the data volume and data rate measurements as input variables and does not need to use other parameters such as QoS parameters values and so on.

The WTRU can use such a function with the measured UL data volume or UL data rate to determine an uplink related EE estimate or Average EC estimate.

The UPF may use a similar function with the measured DL data volume and DL data rate to determine a downlink related EE or average EC estimate.

The WTRU and UPF may exchange the UL and DL EE or EC measurements/estimates via the user plane, and they can consolidate the estimate to determine a unified estimate of the EE or average EC for the SDF or QoS flow for the access.

For example, the WTRU and UPF can add the estimates of UL average EC and DL average EC. Energy consumption estimate=average EC UL estimate+average EC DL estimate.

Similarly, the WTRU and the UPF may use the estimate of UL EE and DL EE when using a certain access node, and perhaps average them to obtain an EE estimate.

In this scenario, the WTRU may be provided with measurement assistance information (MAI) that includes energy related measurement method and parameters. The UPF may be provided with similar information via the N4 rules. The measurement assistance information may be determined by the PCF, using energy related information from the NWDAF, and is included in the PCC rules for the traffic flows of interest.

The energy related measurement assistance information may include the function that the WTRU or UPF will use to estimate the UL or DL energy related measurement. The WTRU and UPF may be provided with a function template using some parameters, e.g., f(x)=a\hat{ }b, and the WTRU and UPF are provided with specific values of the parameters a and b. The WTRU and UPF may also be configured to expect refreshed or updated values for the parameters (e.g., a and b), that they can use to obtain more accurate estimates.

In case the function template itself is no longer valid, which may happen less frequently, the WTRU and UPF may receive an updated template for the function template.

The WTRU and UPF may further be with parameters for the function that is used to estimate energy related information, for each QoS flow that will undergo the energy related information estimation (e.g., that carries traffic that uses energy aware priority based or highest EE steering modes, with energy related threshold values). The MAI may include two template functions, one for the 3gpp access and another one for the non 3gpp access. The MAI may also include how the WTRU (resp. the UPF) consolidate EE or EC measurement obtained from the UPF (resp. the WTRU) with their own measurement.

The functions to be used by the WTRU and UPF to derive partial EE or EC estimates and then consolidate the partial measurements, is supposed to be a simple function, as opposed to an advanced or complex function (e.g., ML model) that can be used by the NWDAF in the 5GS, and the partial measurements may be exchanged by the WTRU and the UPF via the User plane.

This allows a fast and accurate enough estimate of the EE or EC related levels.

More than one threshold with split percentage may be provided for the load balancing.

In step 203e (Npcf_SMPolicyControl_UpdateNotify (energy estimate report for MA PDU session)), the PCF sends the PCC rules to the SMF including the MA PDU session control information.

In step 204 (Determine QoS profile, N4 rules, QoS rules and ATSSS rules (select an energy aware steering mode, and configure energy related measurement for UE and UPF)), the SMF uses the PCC rules received from the PCF, to derive ATSSS rules for the WTRU and N4 rules that include traffic steering information to the UPF. The SMF may also derive QoS rules for the WTRU.

The SMF may also be configured along with the UPF and RAN nodes to provides measurement related to data rate, data volume for the traffic flows of interest. The SMF may send these measurements to the NWDAF in order to obtain a more accurate estimate of the energy efficiency or energy consumption related to the traffic flows or QoS flows over the 3gpp or non-3gpp legs.

The SMF may determine that access performance measurement should be applied for the PDU session. The access performance measurement may be related to the energy consumption or energy efficiency related to the QoS flow of interest. The SMF may make this determination based on the MA PDU session control information received from the PCF in the PCC rules. For example, if an energy aware steering mode, with highest energy efficiency steering mode is to be applied for the service data flow, the SMF may determine that a measurement of the energy efficiency related to the traffic flow of interest of QoS flow, for a certain access type.

The SMF may configure the WTRU to perform access performance measurement. The indication that the WTRU needs to perform the access performance measurement can be sent to the WTRU in the QoS rules. The SMF may configure the UPF to perform access performance measurement. The indication that the UPF needs to perform the access performance measurement can be sent to the WTRU in the N4 rules.

The SMF may also generate a QoS profile to the RAN node. The SMF may include instructions to the RAN on how to report data volume, data rate calculations, and perhaps provide energy related information.

The SMF then sends the N4 rules to the UPF, the QoS profile to the RAN, in step 205 (Steps 10a-14 of MA PDU session establishment procedure, from clause 4.22.2.1 of TS 23.502 (select an energy aware steering mode/parameters, generate/update energy related measurement assistance information)), using steps 10-from the MA PDU session establishment procedure from clause 4.22.2.1 of TS 23.502.

In step 206a (Send traffic in MA PDU session using energy aware steering mode) and 206b (Send/receive data flow), the WTRU receives UL data from an application hosted on the WTRU and sends this data to the UPF using the energy aware traffic steering mode, from the ATSSS rules.

Using the energy aware traffic steering mode from the ATSSS rules means that the WTRU uses the ATSSS rules and energy consumption information to determine what access leg each PDU is sent over.

Similarly, the UPF receives downlink traffic from an application server, and uses the N4 rules to transmit the data flow to one or the other access, using the energy aware steering mode.

Using the using the N4 rules means that the UPF uses the N4 rules and energy consumption information to determine what access leg each PDU is sent over.

In step 207a (Perform EE/EC measurement for UL) and step 207b (Perform EE/EC measurement for DL), the WTRU and the UPF perform energy efficiency/Average energy consumption estimates, according to the configuration provided by the SMF in step 205.

The WTRU may determine energy related estimates for the UL direction, and the UPF may determine energy related estimates for the DL direction.

In step 207c (Exchange partial energy related measurements), the WTRU and UPF may exchange their (partial) energy related estimates, via the user plane.

In step 207d (Consolidate//EC measurement result/determine threshold is exceeded), once the WTRU receives the energy related estimate for the DL from the UPF, the WTRU may aggregate and consolidate the UPF energy estimates with WTRU energy estimates and determine consolidated energy related estimates. This may include the sum of the average energy consumption for the UL and DL direction for the QoS flow, for the access of interest in the MA PDU session.

This may also include, an average of the energy efficiency estimates for the UL and DL direction, for the QoS flow, for the access of interest.

Similarly, the UPF consolidate energy estimates from the WTRU and the UPF energy estimates, although not shown in this Figure.

In step 208a (Update steering strategy: split traffic/switch to low priority traffic.), the WTRU uses the energy estimates and compare them with the energy threshold, configured with the energy aware steering mode.

The WTRU may determine to update the steering strategy. For example, energy aware priority based steering mode may be configured for the WTRU and the UPF for traffic steering for the traffic of interest.

In this case, for example, based on energy efficiency estimate or average energy consumption estimate for the QoS flow and access for both accesses, the 3gpp access is selected as the high priority access for the SDF, or high energy efficiency/low average energy consumption access. In step 6, the WTRU and UPF steer the SDF traffic on the 3gpp access. The WTRU and UPF are also provided with energy related threshold to use for the energy measurements.

Based on the energy estimates determined by and exchanged between the WTRU and the UPF, the WTRU may determine that the energy efficiency of the high EE access is lower than the EE threshold, hence the EE of the access is degraded. In this case, the WTRU and UPF may determine to split the SDF over both the 3gpp access and non 3gpp access.

In step 208b (Send data traffic according to new energy aware steering mode/params.), once the WTRU (and UPF) determine the updated energy aware steering strategy, the WTRU and UPF exchange SDF traffic according to the updated steering strategy.

### Energy Aware Joint Qos Determination and Traffic Steering Strategy Configuration

In the previous section, when there is a request to setup resources, e.g., a MA PDU session, with some service and QoS requirements, and also an indication that the energy based UP optimization are preferred, with new energy aware steering modes, the PCF is first triggered to determine QoS parameters for the traffic flow and QoS flows. The PCF then determines to obtain energy related estimates from the NWDAF, for the 3gpp access and the non 3gpp access.

The PCF may then use the energy estimate report from the NWDAF to select the steering mode for the MA PDU session, usually an energy aware steering mode, and also determine the steering parameters (e.g., an energy threshold, energy measurement information and so on).

The PCF generates PCC rules including this information and send it to the SMF to further generate corresponding N4 rules for the UPF, and QoS rules and ATSSS rules for the WTRU.

It may be the case that, the QoS parameters as well as the accesses for the MA PDU session may impact the energy related information (e.g., energy efficiency or average energy consumption) for the traffic flows or QoS flows.

For example, ensuring that packets of a QoS flow are delivered between the PSA UPF and the WTRU no longer than the PDB value, may induce more resources spent by the 5GS, e.g., RAN (for a 3gpp access) and UPF, to ensure this tight delay budget is met.

It is proposed that the determination of the QoS parameters and the selection of traffic steering mode and parameters is determined jointly and simultaneously by the PCF, based on energy estimate report obtained from the NWDAF.

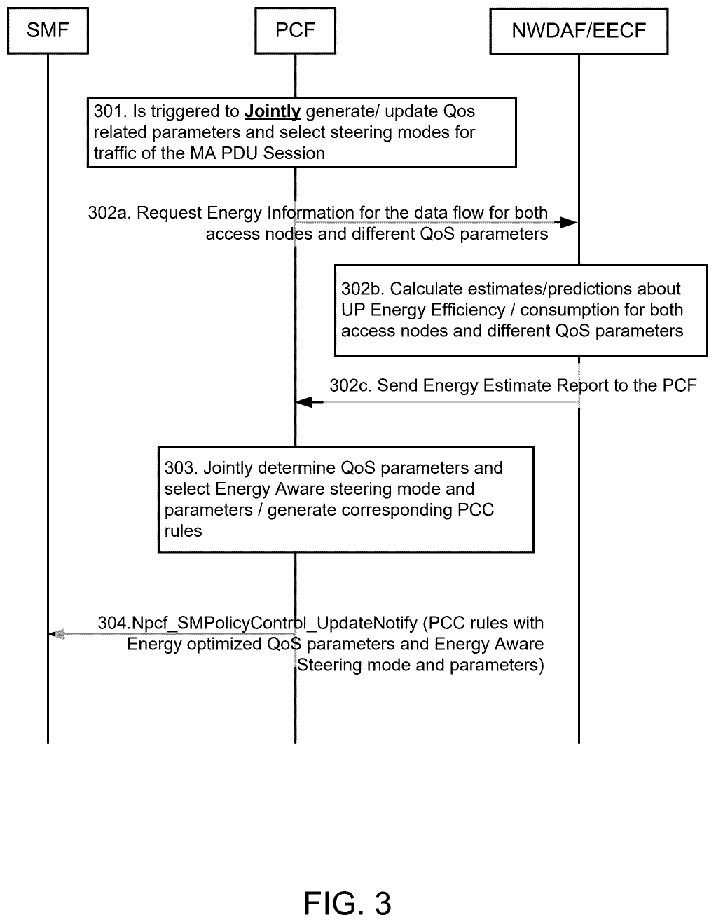

See FIG. 3, that shows triggering of the PCF to jointly determine QoS parameters and steering policies, to optimize UP energy efficiency.

In step 301 (PCF is triggered to jointly generate/update QoS related parameters and select steering modes for traffic of the MA PDU session), the PCF is triggered to jointly determine QoS parameters and MA access steering mode related to the traffic flows and QoS flows. The PCF may be triggered to jointly determine QoS parameters and select steering modes and parameters for the flows of the MA PDU session based on different events.

In a first example, the PCF may receive a request from the SMF serving the PDU session, a request message to create or modify SM policies association. The SMF may include an indication that energy based UP optimization is preferred by the user, and/or include ATSSS energy aware capabilities when a MA PDU session is being established or modified. The WTRU may have included in the PDU session establishment or modification request to the SMF, an indication that the WTRU is flexible with some QoS parameters to be a bit less than the requested values, if there is a 5GS optimization that is needed for the user plane (e.g., an energy based UP optimization).

For example, the AF may indicate that it is flexible with a small degradation of the PER if energy aware UP optimization related to the traffic of interest are needed.

Alternatively, the PCF may receive from an AF either directly or via the NEF to create or update an AF session with required QoS. The AF may provide service description and QoS requirements, and potentially an indication that the AF may be flexible with some QoS parameters values, if an optimization (e.g., energy related UP optimization) needs to be performed by the 5GS. The PCF may determine that the traffic would be carried by the MA PDU session, where energy aware steering capabilities are supported.

The PCF may determine that joint QoS determination and traffic steering strategy need to be performed simultaneously/jointly, based on the fact that the network may be congested or the energy efficiency or energy related metrics for the 5GS may be degrading.

For example, if the network may go through a congestion in the user plane while having an energy efficiency or average energy consumption goal, then the 5GS and PCF may determine that careful selection of QoS parameters and (energy aware) steering strategy need to take place in order to not over reserve limited network resources.

The AF may provide the PCF, when request an AF session, with a performance metric that includes an energy related and QoS related parameters.

One example of such a performance metric can be PerMet=EE/PDB, which is the quotient of the energy efficiency and the packet delay budget. The PCF may be triggered to optimize or improve the performance metric PerMet, which combines both a QoS parameter that is the Packet delay budget for the data flows (or QoS flows), and an energy related parameter that is the energy efficiency related to the traffic flows or QoS flows.

If the goal is to improve the PerMet metric, then EE/PDB needs to be increased.

One way to improve the PerMet is to reduce the PDB, while the EE value is fixed. This may mean that if the packet delay budget value is reduced while the energy efficiency level is maintained, then the quotient increases and hence PerMet and the desired performance will improve.

Another way to improve PerMet is by increasing the value of EE, while PDB value is fixed.

This may mean that if the PDB level is maintained while the energy efficiency level increases, then the PerMet and hence the desired performance increases.

It may also be possible to update both the PDB value and the EE values, simultaneously, so that the quotient EE/PDB increases.

In the above example and previous scenarios, the energy performance may be impacted by the choice of the QoS parameters.

Furthermore, using specific QoS parameters set over one access (e.g., 3gpp) may have a different impact on energy metric than sending the same QoS parameters set over the other access of a MA PDU session (e.g., non 3gpp).

Therefore, the determination of QoS parameters as well as the ATSSS mechanism may be optimized when performed jointly, instead of separately.

In step 302a (Request energy information for the data flow for both access nodes and different QoS parameters), the PCF determines to obtain energy estimates related to the traffic flows and QoS flows of interest.

The PCF may include the WTRU ID, PDU session ID, RAN ID, N3IWF ID (TNGF ID) and UPF ID in the input parameters of the request. The PCF may also include the DNN and S-NSSAI values if available.

The PCF may include the QoS requirements that were received (e.g., from the AF), for example PDB, PER values, a flow resource type (e.g., a GBR or non-GBR resource), priority level and so on.

The PCF may include a range of values for some of the QoS parameters and indicate that a value of the QoS parameter within the indicate range is acceptable. The PCF may include resolution parameter to indicate what is the increment step(s) that should be used by the NWDAF to span the QoS parameter range. The PCF may include a set of possible or acceptable values for the QoS parameters (instead of a range of values).

The PCF may include a desired value or a range of desired values for an energy related metric, such as energy efficiency level or average energy consumption level.

For example, the PCF may indicate that the energy efficiency of the SDF or QoS flow that they carry need to be equal or above 70%.

In another example, the PCF may indicate that the energy efficiency averaged over all GBR or non-GBR (or both) QoS flows over both accesses is above a certain threshold value.

In step 302b (Calculate estimates/predictions about UP energy efficiency/consumption for both access nodes and different QoS parameters), once the NWDAF receives energy estimate request from the PCF, the NWDAF calculates estimate or predictions about the UP-energy efficiency/average energy consumption for the 3gpp and non-3gpp access and for different values of QoS parameters.

The NWDAF may use data already collected or collects recent data related to data rates that are used for the different SDFs, QoS flows of the MA PDU session. The NWDAF may also collect or use information about the (average) data volume that has been used for each SDF or QoS flow of the MA PDU session.

The NWDAF may use an ML model to help determine energy related estimates.

The NWDAF may determine energy estimates with the following attributes.

The NWDAF may calculate an estimate of the energy efficiency of the QoS flow carrying a certain SDF, when the QoS flow has certain QoS parameters, and using a certain access.

The NWDAF may calculate this estimate of the EE, for different possible values of the QoS parameters set.

The NWDAF may similarly calculate the average energy consumption that is incurred when a certain SDF is carried within a specific QoS flow, over a certain access (either 3gpp or non-3gpp).

The NWDAF may calculate estimates of the average energy efficiency or average energy consumption over multiple QoS flows of the MA PDU session and potentially averaging over both accesses of the MA PDU session.

In step 302c (Send energy estimate report to the PCF), the NWDAF sends the energy estimate report to the PCF.

In step 303 (Jointly determine QoS parameters and select energy aware steering mode and parameters/generate corresponding PCC rules), the PCF uses the energy estimate report obtained from the NWDAF to determine QoS parameters and both accesses of the MA PDU session, to determine the QoS parameters values and the energy aware steering mode and steering parameters for the traffic flows and QoS flows.

For example, the PCF may determine the QoS parameters and the energy aware steering mode and parameters, that incur higher/the highest energy efficiency for the SDF, or QoS flow (or access or MA PDU session).

Alternatively, the PCF may obtain a target QoE metric for a flow. The target QoE metric for a flow maybe provided to the PCF by the SMF during a PDU session Establishment procedure or a PDU session Modification procedure. The target QoE metric for a flow maybe provided to the PCF by the AF when the AF invokes an API of the PCF.

The target QoE metric may be provided to the NWDAF instead of providing QoS requirements (e.g. PDB and PER) to the NWDAF. The NWDAF may then provide QoS requirements to the PCF. The QoS Requirements that are provided to the PCF may be based on the target QoE and the energy efficiency requirement of the PDU. The energy efficiency requirement of the PDU session is provided to the NWDAF by the PCF.

MOS is an example of a QoE Metric.

In step 304 (Npcf_SMPolicyControl_UpdateNotify (PCC rules with energy optimized QoS parameters and energy aware steering mode and parameters)), the PCF uses the determined QoS parameters to generate PCC rules and sends the generated/updated PCC rules to the SMF.

### Converting a Single Access PDU Session to a MA PDU Session, Based on Energy Related Information

In previous sections, the 5GS is able to configure a Multi-access PDU session to carry traffic between the WTRU and an application server. The WTRU included an indication that it supports ATSSS, the WTRU included energy aware steering capabilities as supported, and the WTRU also included a preference for optimizations based on UP energy related information.

In another scenario, a WTRU may request to establish a single access PDU session with the 5GS, and the 5GS may determine to switch the PDU session to a MA PDU session.

It is proposed, according to embodiments, that the 5GS may leverage energy related information (e.g., estimates) for 3gpp and non-3gpp access and other aspects, to determine to switch a single access PDU session to a MA PDU session. Leveraging energy related information mean using energy related information to determine when to switch a single access PDU session to an MA PDU session.

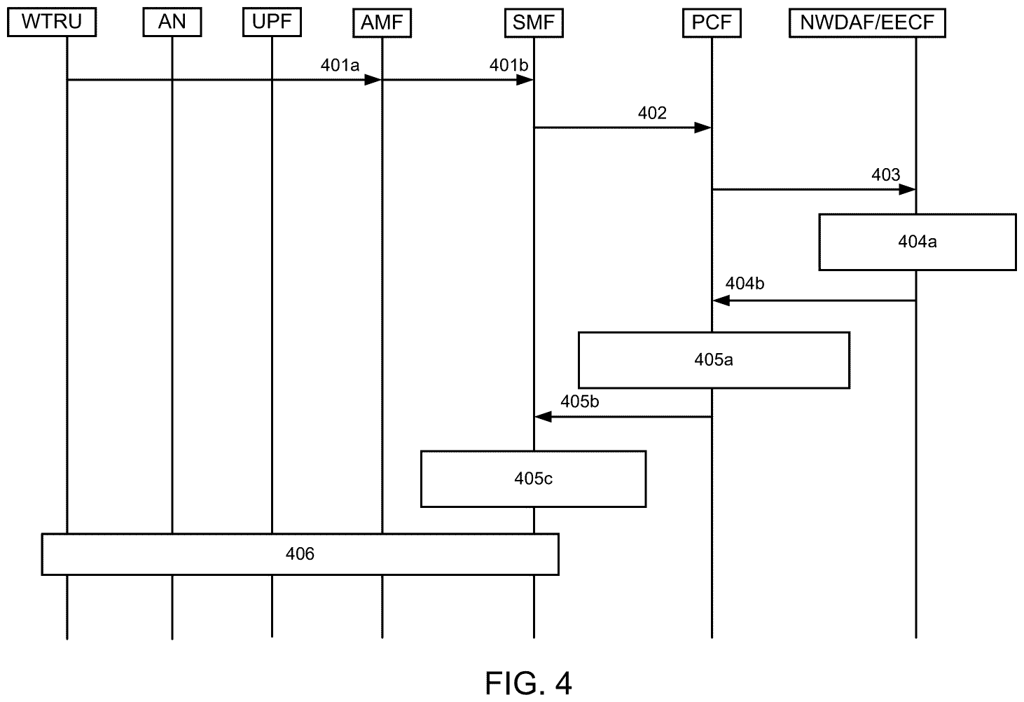

See FIG. 4 that shows an embodiment of a procedure for single access to MA PDU session conversion based on access types related UP energy related information.

In step 401a and 401b (both: PDU session establishment request (Request type =“MA PDU Network-Upgrade Allowed”, energy aware ATSSS capabilities, energy related UP optimization preference)), the WTRU may send a PDU session establishment request to the 5GS.

The WTRU may set the Request type to “initial request” to indicate that this is a PDU session establishment request. The WTRU may also include in the request message the indication “MA PDU Network-Upgrade Allowed” in UL NAS Transport message. The “MA PDU Network-Upgrade Allowed” (as described in 4.22.3 of TS 23.502) indicates that the requested single access PDU session may be converted to a MA PDU session, if the network wants to. The WTRU may also include its ATSSS capabilities in the request message.

The WTRU may include energy aware ATSSS capabilities such as new energy aware steering modes and parameters.

The WTRU may indicate “MA PDU energy-based Network-Upgrade Allowed”. This alternative indication may mean that the WTRU authorizes for the single access PDU session to be converted to a MA PDU session by the 5GS, if the network decision is based on (user plane) energy saving/energy efficiency purposes.

The WTRU may include the original “MA PDU Network-Upgrade Allowed” indication and add allowed cause or trigger values for the upgrade to “UP energy efficiency optimization”.

When the AMF receives the “MA PDU Network-Upgrade Allowed” indication, or alternative indications as mentioned in step 1, the AMF sends a “MA PDU Network-Upgrade Allowed”indication to the SMF, and not the “MA PDU session”indication.

Later on, the SMF may decide whether to convert the single access PDU session to MA PDU session.

In step 402 (SM policy association create (“MA PDU Network-Upgrade Allowed”, (energy aware ATSSS capabilities, energy related UP optimization preference)), the SMF indicates to the PCF that the SM policy control information is request a MA PDU session via the “MA PDU Network-Upgrade Allowed”indication.

The SMF may provide the PCF with the ATSSS capabilities which include energy aware steering modes and parameters.

In this case, the PCF may determine based on the “MA PDU energy-based Network-Upgrade Allowed” or the “MA PDU Network-Upgrade Allowed” indication with a cause or trigger value of “UP energy efficiency”, that energy estimates related to the different access types for the MA PDU session and single access PDU session are needed.

In step 403 (Request energy estimates for the single access and multi access scenarios), the PCF sends a request to the NWDAF/EECF to obtain energy estimates for the different access types for MA PDU session and the currently used single access PDU session.

The PCF may include the DNN/S-NSSAI values for the PDU session. The PCF may also include the different access types that the MA PDU session would use, e.g., 3gpp and non-3gpp access.

The PCF also provides the currently used access type and RAT type to the NWDAF.

The PCF may include QoS parameters if provided by the WTRU, or default QoS parameters from the WTRU subscription information, in the request for energy estimate to the NWDAF.

The PCF may include an application ID.

The PCF may also include threshold values for energy efficiency and average energy consumption.

The PCF may include a delta value to indicate how much better the MA PDU session should be compared to the single access PDU session, in terms of energy efficiency or average energy consumption, for the PCF to consider switch the PDU session to MA PDU session.

In step 404a (Calculate estimates/predictions about UP energy efficiency/consumption for single access/MA PDU sessions scenarios), the NWDAF uses the input information from the PCF request to determine estimates of the energy efficiency or average energy consumption for the access type and RAT type that the single access PDU session is currently using, for the different access types that the MA PDU session may use.

The NWDAF may provide an indicate of the difference in terms of EE or EC between using the single access and MA PDU session.

The NWDAF may also provide energy related threshold values that can be used for access performance measurements, when a MA PDU session is used, and different energy aware steering modes are used.

In step 404b (Send energy estimate report to the PCF), the NWDAF then sends the energy estimate report to the PCF.

In step 405a (Determines based on energy estimates to convert the single access PDU session to a MA PDU session Generates PCC rules including (energy aware steering modes) ), the PCF uses the energy estimate report obtained from the NWDAF to determine that the PDU session should be converted to a MA PDU session, for energy efficiency purposes.

The PCF generates PCC rules for the PDU session and traffic flows of interest.

The PCC rules may include MA traffic steering policies, energy related access measurement assistance information, as well as QoS parameters and other parameters.

In step 405b (Npcf_SMPolicyControl_UpdateNotify (energy estimate report for MA PDU session)), the PCF sends these rules to the SMF.

In step 405c (Determine QoS profile, N4 rules, QoS rules and ATSSS rules (select an energy aware steering mode, and configure energy related measurement for UE and UPF)), the SMF then determines N4 rules for the UPF, QoS profile for the RAN, and QoS rules and ATSSS rules for the WTRU.

In step 406 (Step 205 of FIG. 2-P DU session establishment accept (includes “MA PDU Session Accepted”, cause=UP energy efficiency, energy aware ATSSS rules)), the SMF sends a “MA PDU session Accepted” indication to the AMF. The AMF marks the PDU session as MA PDU session.

The SMF may include a field for the cause of the “MA PDU session accept” indication. The cause value may have value “UP energy efficiency”.

A PDU session establishment accept message includes energy aware ATSSS rules which indicate that the requested PDU session was converted by the network, potentially for UP energy efficiency purposes, to a MA PDU session.

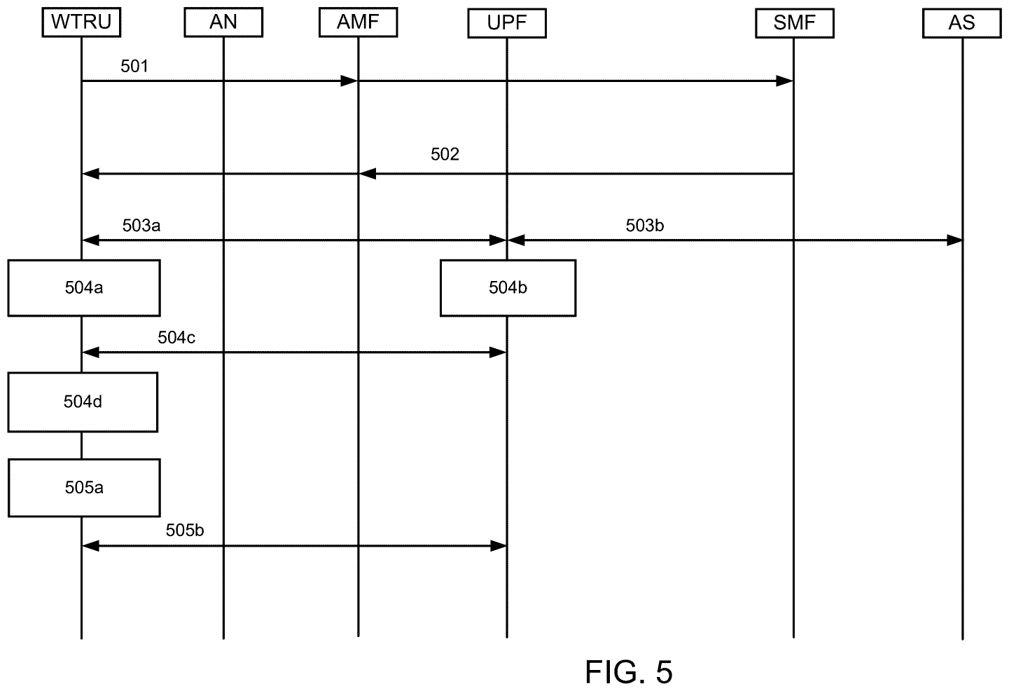

FIG. 5 is a sequence chart of a method according to an embodiment, wherein the focus is set to the WTRU. According to an embodiment, a WTRU may:

send a request to establish a Multi-access PDU session, and include an indication of support of ATSSS and includes energy aware steering capabilities (e.g. energy efficiency steering modes);

additionally send an indication that energy cost based, user plane optimization is preferred/required for the data session;

the support indication and preference indication may be sent in a PDU session establishment request message, to the SMF;

receive QoS rules ATSSS rules including energy aware steering modes that are selected to be used, including energy cost related thresholds;

receive (in the QoS rules) configuration parameters for energy cost measurement at the UE. The configuration information may include a template to express how to estimate the energy cost by the UE. The template may include which variables to use for energy cost estimation (data volume and or data rate);

the QoS rules and ATSSS rules may be received via a PDU session establishment response message or a PDU session modification command message;

exchange data traffic with a UPF function (receive DL traffic and send UL traffic) and send uplink traffic according to initial (first) energy aware steering mode;

perform local energy cost estimation;

exchange with UPF local energy cost measurement;

consolidate energy cost estimate using local information from UE itself and UPF;

determine, based on determined energy cost estimate, an updated traffic steering strategy;

send uplink traffic according to the updated (second) steering strategy.

See FIG. 5; in 501 (PDU session establishment request (Request type=“MA PDU Request”, energy aware ATSSS capabilities, energy related UP optimization preference)), the WTRU may send a PDU session establishment request message to the 5GS. The request message may include a request type “MA PDU Request” in UL NAS transport message to indicate that the request PDU session type is a multi-access PDU session. The WTRU may also include in the UL NAS transport message its ATSSS capabilities in the request message. The ATSSS capabilities may describe steering modes that the WTRU supports. The ATSSS capabilities may include new energy aware steering modes. The request message may also include an indication that UP energy optimization is preferred for this PDU session.

In 502 (PDU session establishment response/PDU session modification command request (select one or more energy aware steering mode/parameters, generate/update energy related measurement assistance information)), the WTRU receives QoS rules and ATSSS rules from the SMF via (e.g.,) a PDU session establishment response message or a PDU session modification command message. The ATSSS rules may include the selected energy aware steering mode to be used by the WTRU, and the related parameters, such as energy cost threshold, steering configuration (e.g., split percentages). The WTRU may be configured to perform energy cost measurement and to consolidate energy measurement with energy measurement exchanged with the UPF.

In 503a (Send traffic in MA PDU session using (initial) energy aware steering mode) and in 503b (Send/receive data flow), the WTRU receives UL data from an application hosted on the WTRU and sends this data to the UPF using the energy aware traffic steering mode, from the ATSSS rules.

In 504a (Perform EE/EC measurement for UL), the WTRU perform energy efficiency/Average energy consumption estimates, according to the configuration provided by the SMF in 502. The WTRU may determine energy related estimates for the UL direction, and the UPF may determine energy related estimates for the DL direction, in 504b (Perform EE/EC measurement for DL).

In 504c (Exchange partial energy related measurements), the WTRU and UPF may exchange their (partial) energy related estimates, via the user plane.

In 504d (Consolidate//EC measurement result/determine threshold is exceeded), once the WTRU receives the energy related estimate for the DL from the UPF, the WTRU may aggregate and consolidate the UPF energy estimates with WTRU energy estimates and determine consolidated energy related estimates. This may include the sum of the average energy consumption for the UL and DL direction for the QoS flow, for the access of interest in the MA PDU session. This may also include, an average of the energy efficiency estimates for the UL and DL direction, for the QoS flow, for the access of interest.

Similarly, the UPF consolidates energy estimates from the WTRU and the UPF energy estimates, although not shown in this Figure.

In 505a (Update steering strategy: split traffic/switch to low priority traffic.), the WTRU uses the energy estimates and compare them with the energy threshold, configured with the energy aware steering mode.

The WTRU may determine to update the steering strategy. For example, energy aware priority based steering mode may be configured for the WTRU and the UPF for traffic steering for the traffic of interest.

In this case, for example, based on energy efficiency estimate or average energy consumption estimate for the QoS flow and access for both accesses, the 3gpp access is selected as the high priority access for the SDF, or high energy efficiency/low average energy consumption access. First, in 503, the WTRU and UPF steer the SDF traffic on the 3gpp access. The WTRU and UPF are also provided with energy related threshold to use for the energy measurements.

Based on the energy estimates determined by and exchanged between the WTRU and the UPF, the WTRU may determine that the energy efficiency of the high EE access is lower than the EE threshold, hence the EE of the access is degraded. In this case, the WTRU and UPF may determine to split the SDF over both the 3gpp access and non 3gpp access.

In 505b (Send data traffic according to new energy aware steering mode/params.), once the WTRU (and UPF) determine the updated energy aware steering strategy, the WTRU and UPF exchange SDF traffic according to the updated steering strategy.

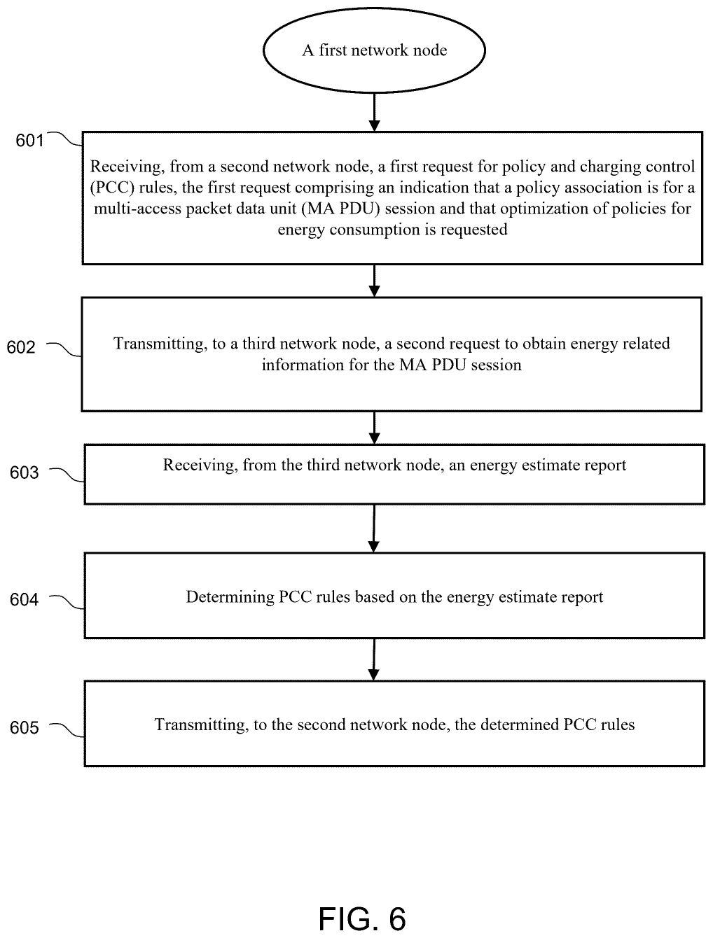

FIG. 6 is a flow chart of an exemplary embodiment of a method implemented by a first network node (e.g., PCF). The method comprises:

In 601, receiving, from a second network node, a first request for policy and charging control (PCC) rules, the first request comprising an indication that a policy association is for a multi-access packet data unit (MA PDU) session and that optimization of policies for energy consumption is requested;

In 602, transmitting, to a third network node, a second request to obtain energy related information for the MA PDU session;

In 603, receiving, from the third network node, an energy estimate report;

In 604, determining PCC rules based on the energy estimate report; and

In 605, transmitting the determined PCC rules to the second network node.

According to an embodiment, the first network node is a policy control function (PCF), the second network node is any one of a session management function (SMF) or an application function (AF), and the third network node is a network data analytics function (NWDAF). The NWDAF is considered to be able to make the calculations related to energy, so the third network node may be considered being part of the NWDAF/being an NWDAF. According to a different embodiment, the energy efficiency control function (EECF) may be hosted or collocated with an NWDAF. According to a further embodiment, the EECF may be a new standalone Network Function.

According to an embodiment, the method comprises receiving desired quality of service (QoS) parameters for one or more flows of the MA PDU session.

According to an embodiment, the second request comprises at least one of: a data network name (DNN) and slice selection assistance information (SSAI) that are associated with the MA PDU session; desired quality of service parameters for one or more flows of the MA PDU session.

According to an embodiment, the energy estimate report comprises energy estimate information for at least a 3GPP access (access network path, e.g., 5G/6G/XG) and a non-3GPP access (access network path, e.g., WiFi) of the MA PDU session.

According to an embodiment, the energy estimate report indicates at least one of: an (assumed, presumed, computed, calculated, estimated, inferred, determined) energy consumption for at least one of the at least a 3GPP access and a non-3GPP access, relative to a target data rate; an estimated energy consumption for at least one of the at least a 3GPP access and a non-3GPP access, relative to a target quality of service metric value; and an (assumed, presumed, computed, calculated, estimated, inferred, determined) energy consumption for at least one of the at least a 3GPP access and a non-3GPP access, relative to a target quality of experience metric value.

According to an embodiment, the transmitted PCC rules comprise an indication that energy aware steering mode is to be enabled for the MA PDU session.

There is also disclosed and described a first network node, comprising at least one processor configured to:

receive, from a second network node, a first request for policy and charging control (PCC) rules, the first request comprising an indication that a policy association is for a multi-access packet data unit (MA PDU) session and that optimization of policies for energy consumption is requested;

transmit, to a third network node, a second request to obtain energy related information for the MA PDU session;

receive, from the third network node, an energy estimate report;

determine PCC rules based on the energy estimate report; and

transmit the determined PCC rules to the second network node.

According to an embodiment, the first network node is a policy control function (PCF), the second network node is any one of a session management function (SMF) or an application function (AF), and the third network node is a network data analytics function (NWDAF). The NWDAF is considered to be able to make the calculations related to energy, so the third network node may be considered being part of the NWDAF/being an NWDAF. According to a different embodiment, the energy efficiency control function (EECF) may be hosted or collocated with an NWDAF. According to a further embodiment, the EECF may be a new standalone Network Function.

According to an embodiment, the at least one processor is configured to receive desired quality of service (QoS) parameters for one or more flows of the MA PDU session.

According to an embodiment, the second request comprises at least one of: a data network name and slice selection assistance information that are associated with the MA PDU session; desired quality of service parameters for one or more flows of the MA PDU session.

According to an embodiment, the energy estimate report comprises energy estimate information for at least a 3GPP access and a non-3GPP access of the MA PDU session.

According to an embodiment, the energy estimate report indicates at least one of: an (assumed, presumed, computed, calculated, estimated, inferred, determined) energy consumption for at least one of the at least a 3GPP access and a non-3GPP access, relative to a target data rate; an estimated energy consumption for at least one of the at least a 3GPP access and a non-3GPP access, relative to a target quality of service metric value; and an (assumed, presumed, computed, calculated, estimated, inferred, determined) energy consumption for at least one of the at least a 3GPP access and a non-3GPP access, relative to a target quality of experience metric value.

According to an embodiment, the transmitted PCC rules comprise an indication that energy aware steering mode is to be enabled for the MA PDU session.

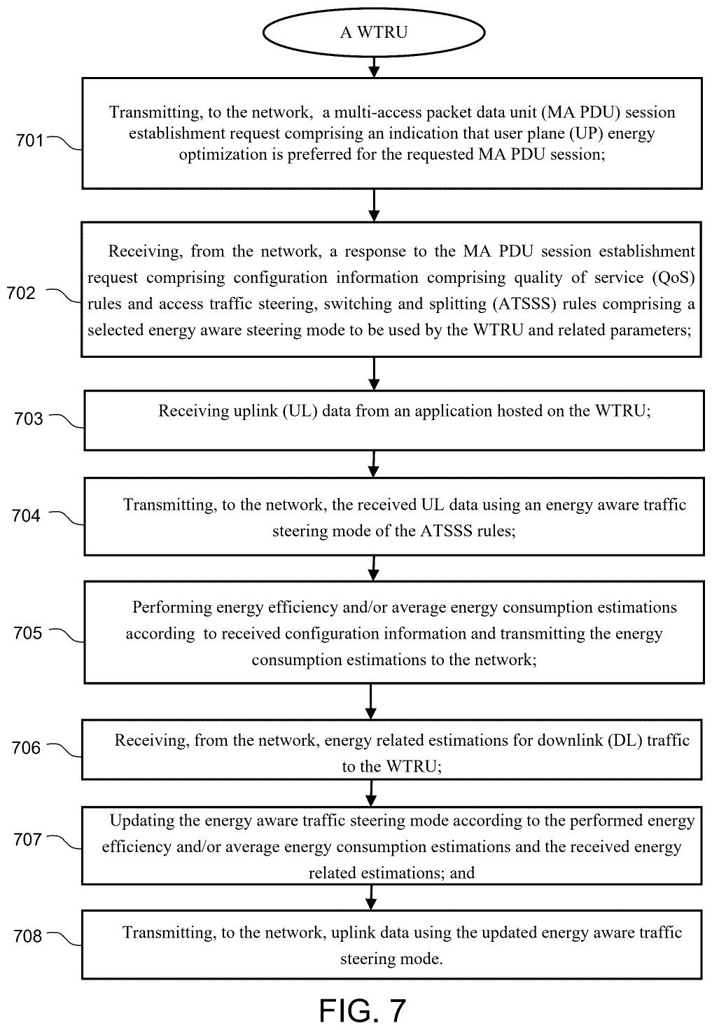

FIG. 7 is a flow chart of a method according to an embodiment, implemented by a WTRU in a network, the method comprising:

Transmitting (701), to the network, a multi-access packet data unit (MA PDU) session establishment request comprising an indication that user plane (UP) energy optimization is preferred for the requested MA PDU session;

Receiving (702), from the network, a response to the MA PDU session establishment request comprising configuration information comprising quality of service (QoS) rules and access traffic steering, switching and splitting (ATSSS) rules comprising a selected energy aware steering mode to be used by the WTRU and related parameters;

receiving (703) uplink (UL) data from an application hosted on the WTRU;

transmitting (704), to the network, the received UL data using an energy aware traffic steering mode of the ATSSS rules;

performing (705) energy efficiency and/or average energy consumption estimations according to received configuration information and transmitting the energy consumption estimations to the network;

receiving (706), from the network, energy related estimations for downlink (DL) traffic to the WTRU;

updating (707) the energy aware traffic steering mode according to the performed energy efficiency and/or average energy consumption estimations and the received energy related estimations; and

transmitting (708), to the network, uplink data using the updated energy aware traffic steering mode.

According to an embodiment, the MA PDU session establishment request comprises ATSSS capabilities of the WTRU that comprise at least one energy aware steering mode supported by the WTRU.

According to an embodiment, the response in reply to the MA PDU session establishment request is a PDU session establishment response message or a PDU session modification command message.

According to an embodiment, the related parameters included in the ATSSS rules comprise at least one of an energy cost threshold and a steering configuration.

According to an embodiment, updating the energy aware traffic steering mode comprises selecting a traffic steering mode wherein uplink data is split over a first access network path and second access network path.

According to an embodiment, the first access network path is a 3GPP access network path, and the second access network path is a non-3GPP access network path.

There is also disclosed and described a WTRU in a network, comprising at least one processor configured to:

transmit, to the network, a multi-access packet data unit (MA PDU) session establishment request comprising an indication that user plane (UP) energy optimization is preferred for the requested MA PDU session;

receive, from the network, a response to the MA PDU session establishment request comprising configuration information comprising quality of service (QoS) rules and access traffic steering, switching and splitting (ATSSS) rules comprising a selected energy aware steering mode to be used by the WTRU and related parameters;

receive uplink (UL) data from an application hosted on the WTRU;

transmit, to the network, the received UL data using an energy aware traffic steering mode of the ATSSS rules;

perform energy efficiency and/or average energy consumption estimations according to received configuration information and transmit the energy consumption estimations to the network;

receive, from the network, energy related estimations for downlink (DL) traffic to the WTRU;

update the energy aware traffic steering mode according to the performed energy efficiency and/or average energy consumption estimations and the received energy related estimations; and

transmit, to the network, uplink data using the updated energy aware traffic steering mode.

According to an embodiment, the at least one processor is configured to comprise, in the MA PDU session establishment request, ATSSS capabilities of the WTRU that comprise at least one energy aware steering mode supported by the WTRU.

According to an embodiment, the response in reply to the MA PDU session establishment request is a PDU session establishment response message or a PDU session modification command message.

According to an embodiment, the related parameters included in the ATSSS rules comprise at least one of an energy cost threshold and a steering configuration.

According to an embodiment, updating the energy aware traffic steering mode comprises selecting a traffic steering mode wherein uplink data is split over a first access network path and second access network path.

According to an embodiment, the first access network path is a 3GPP access network path, and the second access network path is a non-3GPP access network path.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S. C. § 112, ¶ 6 or means-plus-function claim format, and any claim without the terms “means for” is not so intended.

What is claimed is:

1. A method implemented by a first network node, comprising:
receiving, from a second network node, a first request for policy and charging control (PCC) rules, the first request comprising an indication that a policy association is for a multi-access packet data unit (MA PDU) session and that optimization of policies for energy consumption is requested;
transmitting, to a third network node, a second request to obtain energy related information for the MA PDU session;
receiving, from the third network node, an energy estimate report;
determining PCC rules based on the energy estimate report; and
transmitting the determined PCC rules to the second network node.

2. The method according to claim 1, wherein the first network node is a policy control function, the second network node is any one of a session management function or an application function, and the third network node is a network data analytics function.

3. The method according to claim 1, comprising receiving desired quality of service (QoS) parameters for one or more flows of the MA PDU session.

4. The method according to claim 1, wherein the second request comprises at least one of:
a data network name and slice selection assistance information that are associated with the MA PDU session; and
one or more desired quality of service parameters for one or more flows of the MA PDU session.

5. The method according to claim 1, wherein the energy estimate report comprises energy estimate information for at least a 3GPP access and a non-3GPP access of the MA PDU session.

6. The method of claim 5, wherein the energy estimate report indicates at least one of:
an estimated energy consumption for at least one of the at least a 3GPP access and a non-3GPP access, relative to a target data rate;
an estimated energy consumption for at least one of the at least a 3GPP access and a non-3GPP access, relative to a target quality of service metric value; and
an estimated energy consumption for at least one of the at least a 3GPP access and a non-3GPP access, relative to a target quality of experience metric value.

7. The method of claim 1, wherein the transmitted PCC rules comprise an indication that an energy aware steering mode is to be enabled for the MA PDU session.

8. A first network node, comprising at least one processor configured to:
receive, from a second network node, a first request for policy and charging control (PCC) rules, the first request comprising an indication that a policy association is for a multi-access packet data unit (MA PDU) session and that optimization of policies for energy consumption is requested;
transmit, to a third network node, a second request to obtain energy related information for the MA PDU session;
receive, from the third network node, an energy estimate report;
determine PCC rules based on the energy estimate report; and
transmit the determined PCC rules to the second network node.

9. The first network node according to claim 8, wherein the first network node is a policy control function, the second network node is any one of a session management function or an application function, and the third network node is a network data analytics function.

10. The first network node according to claim 8, wherein the at least one processor is configured to receive desired quality of service (QoS) parameters for one or more flows of the MA PDU session.

11. The first network node according to claim 8, wherein the second request comprises at least one of:
a data network name and slice selection assistance information that are associated with the MA PDU session; and
one or more desired quality of service parameters for one or more flows of the MA PDU session.

12. The first network node according to claim 8, wherein the energy estimate report comprises energy estimate information for at least a 3GPP access and a non-3GPP access of the MA PDU session.

13. The first network node of claim 12, wherein the energy estimate report indicates at least one of:
an estimated energy consumption for at least one of the at least a 3GPP access and a non-3GPP access, relative to a target data rate;
an estimated energy consumption for at least one of the at least a 3GPP access and a non-3GPP access, relative to a target quality of service metric value; and
an estimated energy consumption for at least one of the at least a 3GPP access and a non-3GPP access, relative to a target quality of experience metric value.

14. The first network node of claim 8, wherein the transmitted PCC rules comprise an indication that and energy aware steering mode is to be enabled for the MA PDU session.

15. A method, implemented by a wireless transmit-receive unit (WTRU) in a network, the method comprising:
transmitting, to the network, a multi-access packet data unit (MA PDU) session establishment request comprising an indication that user plane (UP) energy optimization is preferred for the requested MA PDU session;
receiving, from the network, a response to the MA PDU session establishment request comprising configuration information comprising quality of service (QoS) rules and access traffic steering, switching and splitting (ATSSS) rules comprising a selected energy aware steering mode to be used by the WTRU and related parameters;
receiving uplink (UL) data from an application hosted on the WTRU;
transmitting, to the network, the received UL data using an energy aware traffic steering mode of the ATSSS rules;
performing energy efficiency and/or average energy consumption estimations according to received configuration information and transmitting the energy consumption estimations to the network;
receiving, from the network, energy related estimations for downlink (DL) traffic to the WTRU;
updating the energy aware traffic steering mode according to the performed energy efficiency and/or average energy consumption estimations and the received energy related estimations; and
transmitting, to the network, uplink data using the updated energy aware traffic steering mode.

16. The method of claim 15, wherein the MA PDU session establishment request comprises ATSSS capabilities of the WTRU that comprise at least one energy aware steering mode supported by the WTRU.

17. The method of claim 15, wherein the response in reply to the MA PDU session establishment request is a PDU session establishment response message or a PDU session modification command message.

18. The method of claim 15, wherein the related parameters included in the ATSSS rules comprise at least one of an energy cost threshold and a steering configuration.

19. The method of claim 15, wherein updating the energy aware traffic steering mode comprises selecting a traffic steering mode wherein uplink data is split over a first access network path and second access network path.

20. The method of claim 19, wherein the first access network path is a 3GPP access network path, and the second access network path is a non-3GPP access network path.
